(19) United States
(12) Patent Application Publication
(10) Pub. No.: US 2025/0253555 A1
(43) Pub. Date: Aug. 7, 2025

(54) Heat Shrink Tube Heating System

(71) Applicants: Raychem Shanghai Cable Accessories Ltd, Shanghai (CN); Tyco Electronics (Shanghai) Co., Ltd., Shanghai (CN); Kunshan League Automechanism Co., Ltd., Kushan City (CN)

(72) Inventors: Zongjie (Jason) Tao, Shanghai (CN); Zheng Fang, Shanghai (CN); Rui Zhang, Shanghai (CN); Hui (Eric) Zhao, Shanghai (CN); Haidong Wu, Kunshan City (CN)

(73) Assignees: Raychem Shanghai Cable Accessories Ltd, Shanghai (CN); Tyco Electronics (Shanghai) Co., Ltd., Shanghai (CN); Kunshan League Automechanism Co., Ltd., Kushan City (CN)

(21) Appl. No.: 19/042,523

(22) Filed: Jan. 31, 2025

(30) Foreign Application Priority Data
Feb. 2, 2024 (CN) 202410154823.3

(51) Int. Cl. H01R 4/72; B29C 61/02; B29L 23/00

(52) U.S. Cl. CPC H01R 4/72; B29C 61/025; B29L 2023/001

(57) ABSTRACT

A heat shrink tube heating system includes a frame, a first and second fixture, and a heating furnace. The first fixture is installed on the frame for clamping one end of a cable product. The second fixture is installed on the frame for clamping the other end of the cable product. The heating furnace is mounted on the frame in a movable manner and has a heating channel that allows the cable product to pass through. The heating furnace is movable along an axial direction of the clamped cable product between the first fixture and the second fixture, for heating a heat shrink tube on the cable product.

### CROSS-REFERENCE TO RELATED APPLICATION

This application claims the benefit of Chinese Patent Application No. CN202410154823.3 filed on Feb. 2, 2024 in the State Intellectual Property Office of China, the whole disclosure of which is incorporated herein by reference.

### FIELD OF THE DISCLOSURE

The disclosure relates to a heat shrink tube heating system, particularly to a heat shrink tube heating system for heating a heat shrink tube on a cable product.

### BACKGROUND OF THE INVENTION

In the prior art, a heating system for heating a heat shrink tube on a cable product usually has drawbacks, such as large volume, complex structure, low heating efficiency, and inconvenient use, and is not suitable for different cable products.

### SUMMARY OF THE INVENTION

According to an embodiment of the present disclosure, a heat shrink tube heating system includes a frame, a first and second fixture, and a heating furnace. The first fixture is installed on the frame for clamping one end of a cable product. The second fixture is installed on the frame for clamping the other end of the cable product. The heating furnace is mounted on the frame in a movable manner and has a heating channel that allows the cable product to pass through. The heating furnace is movable along an axial direction of the clamped cable product between the first fixture and the second fixture, for heating a heat shrink tube on the cable product.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a heat shrink tube heating system according to an exemplary embodiment of the present invention when viewed from one side, wherein a cable product is shown;

FIG. 2 shows an illustrative perspective view of a heat shrink tube heating system according to an exemplary embodiment of the present invention when viewed from one side, wherein the cable product is not shown;

FIG. 3 shows an illustrative perspective view of a heat shrink tube heating system according to an exemplary embodiment of the present invention when viewed from the other side, wherein a cable product is shown;

FIG. 4 shows an illustrative perspective view of a heat shrink tube heating system according to an exemplary embodiment of the present invention when viewed from the other side, wherein the cable product is not shown;

FIG. 5 shows a transverse sectional view of a heat shrink tube heating system according to an exemplary embodiment of the present invention; and

FIG. 6 shows another transverse cross-sectional view of a heat shrink tube heating system according to an exemplary embodiment of the present invention.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided a heat shrink tube heating system. The heat shrink tube heating system comprises: a frame; a first fixture which is installed on the frame for clamping one end of a cable product; a second fixture which is installed on the frame for clamping the other end of the cable product; and a heating furnace which is mounted on the frame in a movable manner and has a heating channel that allows the cable product to pass through. The heating furnace is movable along an axial direction of the clamped cable product between the first fixture and the second fixture, for heating a heat shrink tube on the cable product.

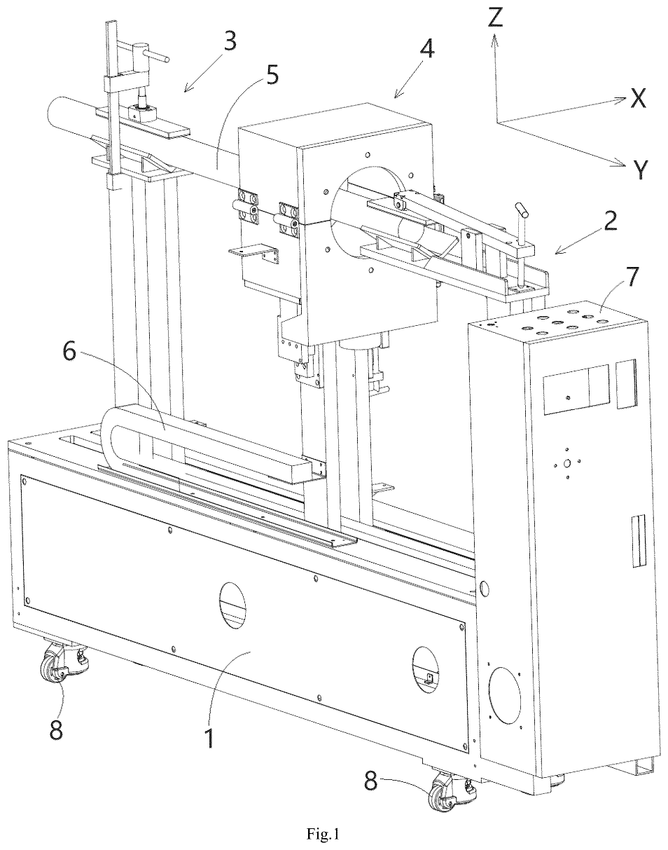

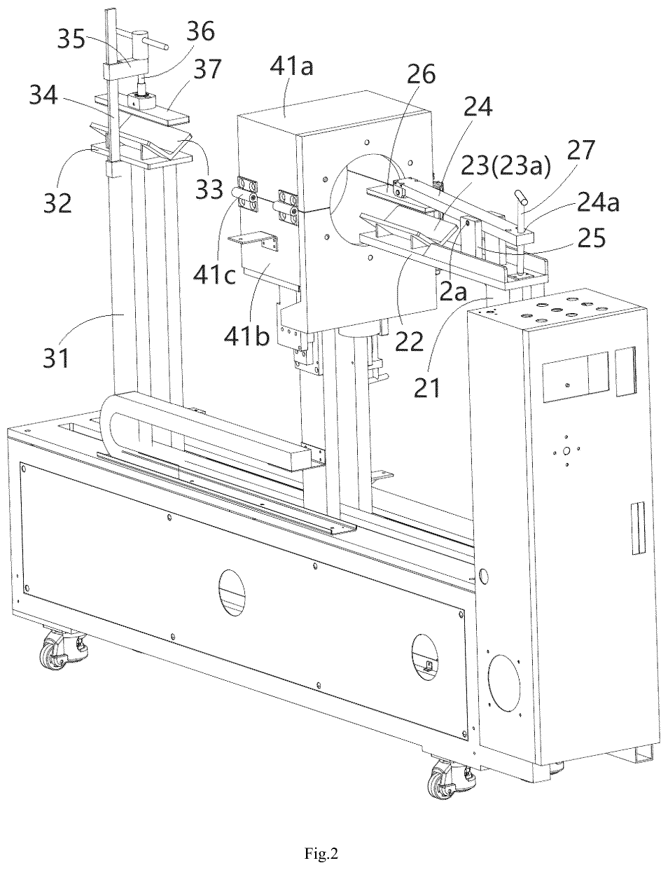

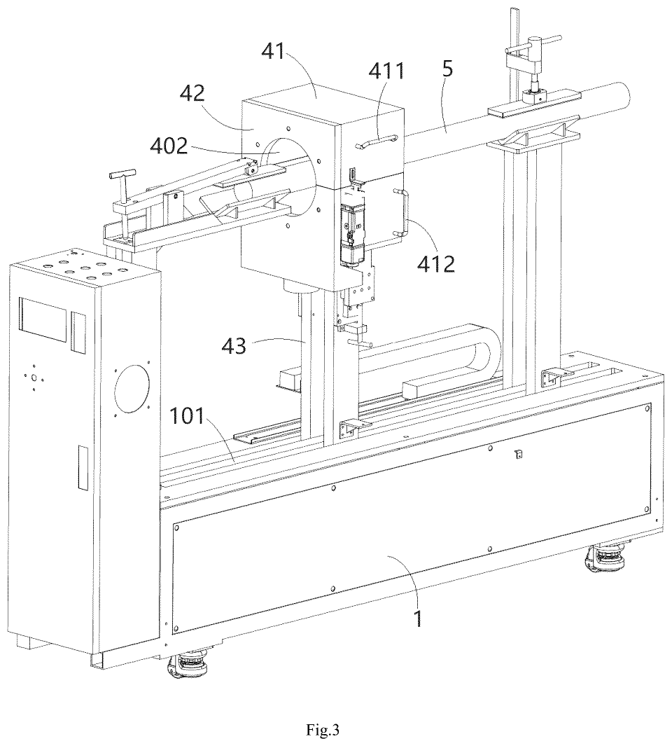

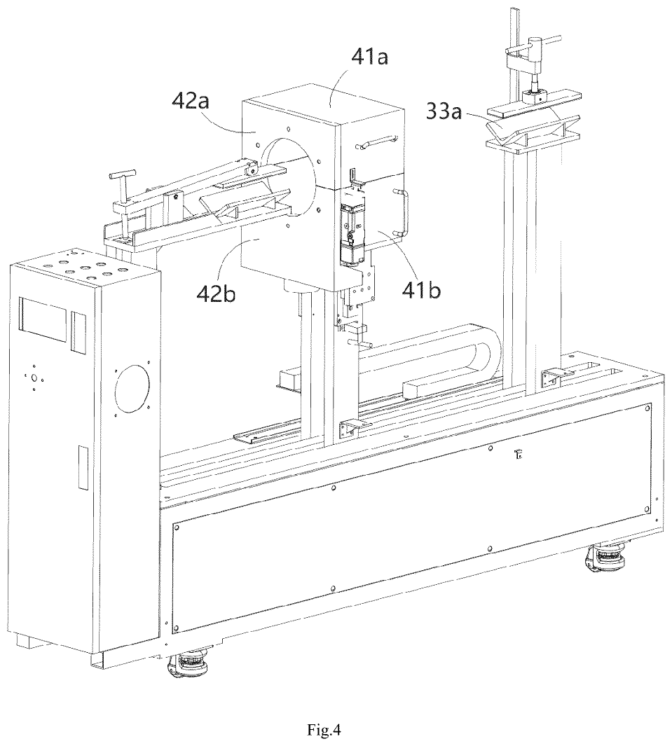

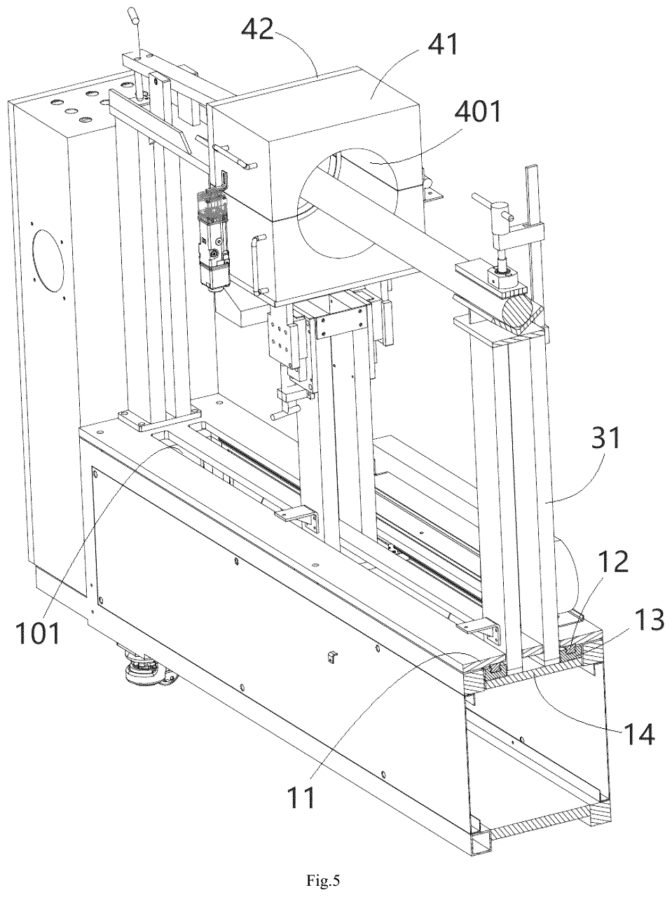

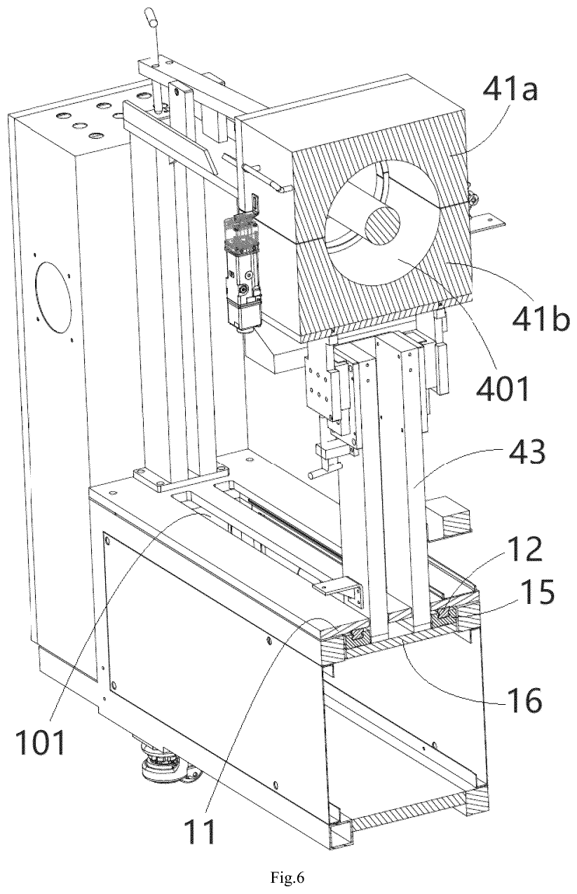

FIG. 1 shows an illustrative perspective view of a heat shrink tube heating system according to an exemplary embodiment of the present invention when viewed from one side, wherein cable product 5 is shown; FIG. 2 shows an illustrative perspective view of a heat shrink tube heating system according to an exemplary embodiment of the present invention when viewed from one side, where cable product 5 is not shown; FIG. 3 shows an illustrative perspective view of a heat shrink tube heating system according to an exemplary embodiment of the present invention when viewed from the other side, wherein cable product 5 is shown; FIG. 4 shows an illustrative perspective view of a heat shrink tube heating system according to an exemplary embodiment of the present invention when viewed from the other side, where cable product 5 is not shown; FIG. 5 shows a transverse sectional view of a heat shrink tube heating system according to an exemplary embodiment of the present invention; FIG. 6 shows another transverse cross-sectional view of a heat shrink tube heating system according to an exemplary embodiment of the present invention.

As shown in FIGS. 1 to 6, in an exemplary embodiment of the present invention, a heat shrink tube heating system is disclosed. The heat shrink tube heating system includes: a frame 1, a first fixture 2, a second fixture 3, and a heating furnace 4. The frame 1 has a longitudinal direction Y, a transverse direction X, and a height direction Z. The first fixture 2 is installed on the frame 1 to clamp one end of a cable product 5. The second fixture 3 is installed on the frame 1 to clamp the other end of the cable product 5. The heating furnace 4 is mounted on the frame 1 in a movable manner and has a heating channel 401 that allows the cable product 5 to pass through. The heating furnace 4 can be moved along the axial direction of the clamped cable product 5 between the first fixture 2 and the second fixture 3, used for heating a heat shrink tube on the cable product 5.

As shown in FIGS. 1 to 6, in the illustrated embodiment, the longitudinal direction Y of the frame 1 is parallel to the axial direction of the clamped cable product 5. The first fixture 2 and the second fixture 3 are opposite in the longitudinal direction Y of the frame 1, and at least one of the first fixture 2 and the second fixture 3 can be moved along the longitudinal direction Y of the frame 1 to clamp cable products 5 of different lengths.

As shown in FIGS. 1 to 6, in the illustrated embodiment, the first fixture 2 is fixedly mounted on the frame 1, and the second fixture 3 is movably mounted on the frame 1, capable of being moved along the longitudinal direction Y of the frame 1.

As shown in FIGS. 1 to 6, in the illustrated embodiment, the first fixture 2 includes a first vertical bracket 21, a horizontal bracket 22, a first V-shaped seat 23, and a first pressing mechanism. The lower end of the first vertical bracket 21 is fixed to the top of the frame 1. One end of the horizontal bracket 22 is fixed to the upper end of the first vertical bracket 21. The first V-shaped seat 23 is fixed on the horizontal bracket 22 and has a first V-shaped groove 23a for positioning the cable product 5. The first pressing mechanism is installed on the horizontal bracket 22, which is used to press one end of the cable product 5 into the first V-shaped groove 23a.

As shown in FIGS. 1 to 6, in the illustrated embodiment, the first pressing mechanism includes a lever member 24, a support member 25, a first screw 27, and a first pressing plate 26. A first threaded hole 24a is formed in one end of the lever member 24. The support member 25 is fixed on the horizontal bracket 22 and is rotatably connected to the lever member 24, so that the lever member 24 can be rotated around a fulcrum 2a. The first screw 27 is threaded into the first threaded hole 24a and passes through it. The first pressing plate 26 is rotatably connected to the other end of the lever member 24. The lower end of the first screw 27 is used to rest on the horizontal bracket 22, and the first pressing plate 26 is used to press one end of the cable product 5 into the first V-shaped groove 23a.

As shown in FIGS. 1 to 6, in the illustrated embodiment, the distance from the fulcrum 2a to the other end of the lever member 24 is greater than the distance from the fulcrum 2a to one end of the lever member 24, in order to increase the pressing force exerted by the first pressing plate 26 on one end of the cable product 5.

As shown in FIGS. 1 to 6, in the illustrated embodiment, the second fixture 3 includes a second vertical bracket 31, a horizontal top plate 32, and a second pressing mechanism. The lower end of the second vertical bracket 31 is mounted on the frame 1 in a movable manner and can be moved along the longitudinal direction Y of the frame 1. The horizontal top plate 32 is fixed to the upper end of the second vertical bracket 31. The second V-shaped seat 33 is fixed on the horizontal top plate 32 and has a second V-shaped groove 33a for positioning the cable product 5. The second pressing mechanism is installed on the second vertical bracket 31, used to press the other end of the cable product 5 into the second V-shaped groove 33a.

As shown in FIGS. 1 to 6, in the illustrated embodiment, the second pressing mechanism includes a vertical rod 34, an installation block 35, a second screw 36, and a second pressing plate 37. The lower end of the vertical rod 34 is fixed to the second vertical bracket 31. The installation block 35 is installed onto the vertical rod 34 and is formed with a second threaded hole. The second screw 36 is threaded into the second threaded hole and passes through it. The second pressing plate 37 is fixed to the lower end of the second screw 36, used to press the other end of the cable product 5 into the second V-shaped groove 33a.

As shown in FIGS. 1 to 6, in the illustrated embodiment, the installation block 35 is mounted on the vertical rod 34 in a movable manner and can be moved along the vertical rod 34. The second pressing mechanism also includes a locking device (not shown) for locking the installation block 35 onto the vertical rod 34.

As shown in FIGS. 1 to 6, in the illustrated embodiment, the frame 1 includes a top plate 11, a slide rail 12, a slider 13, and a connecting plate 14. A slot hole 101 is formed in the top plate 11, extending along the longitudinal direction Y of the frame 1. The slide rail 12 is fixed to the inner side of top plate 11 and extends along the longitudinal direction Y of the frame 1. The slider 13 is engaged with the slide rail 12 to be able to move along the slide rail 12. The connecting plate 14 is fixed to the slider 13 to move together with the slider 13. The lower end of the second vertical bracket 31 passes through the slot hole 101 and is fixed to the connecting plate 14, allowing the second fixture 3 to move along the longitudinal direction Y of the frame 1.

As shown in FIGS. 1 to 6, in the illustrated embodiment, the heating furnace 4 includes a movable bracket 43 and a heating furnace body 41. The lower end of the movable bracket 43 is mounted on the frame 1 in a movable manner and can be moved along the longitudinal direction Y of the frame 1. The heating furnace body 41 is supported on the movable bracket 43 and formed with a heating channel 401. The heating furnace body 41 includes a lower half furnace body 41b and an upper half furnace body 41a combined together. The lower half furnace body 41b is fixed to the movable bracket 43, and one side of the upper half furnace body 41a is rotatably connected to one side of the lower half furnace body 41b, so that the upper half furnace body 41a can be opened and closed relative to the lower half furnace body 41b.

As shown in FIGS. 1 to 6, in the illustrated embodiment, the heating furnace body 41 has left and right sides that are opposite to each other in the transverse direction of the frame 1, and the left sides of the upper and lower half furnace bodies 41a and 41b are rotatably connected together by a hinge 41c.

As shown in FIGS. 1 to 6, in the illustrated embodiment, the heating furnace 4 further comprises a first handle 411 and a second handle 412. The first handle 411 is connected to the right side of the upper half furnace body 41a to allow the operator to open or close the upper half furnace body 41a through the first handle 411. The second handle 412 is connected to the right side of the lower half furnace body 41b to allow the operator to drive the heating furnace 4 to move along the longitudinal direction Y of the frame 1 through the second handle 412.

As shown in FIGS. 1 to 6, in the illustrated embodiment, the heating furnace body 41 has front and rear sides that are opposite in the longitudinal direction Y of the frame 1. The heating furnace 4 also includes a cooling module 42, which is installed on the front or rear side of the heating furnace body 41 to cool the heating furnace body 41 to a predetermined safe temperature.

As shown in FIGS. 1 to 6, in the illustrated embodiment, the cooling module 42 includes upper and lower cooling blocks 42a and 42b respectively fixed to the upper and lower half furnace bodies 41a and 41b. A circular through-hole 402 is formed in the cooling module 42, which is aligned with the heating channel 401 of the heating furnace body 41 and allows the cable product 5 to pass through.

As shown in FIGS. 1 to 6, in the illustrated embodiment, the frame 1 comprises: the aforementioned top plate 11, the aforementioned slide rail 12, a sliding block 15, and a mounting plate 16. A slot hole 101 is formed in the top plate 11, extending along the longitudinal direction Y of the frame 1. The slide rail 12 is fixed to the inner side of the top plate 11 and extends along the longitudinal direction Y of the frame 1. The sliding block 15 is engaged with the slide rail 12 to be able to move along the slide rail 12. The mounting plate 16 is fixed to the sliding block 15 to move together with the sliding block 15. The lower end of the movable bracket 43 passes through the slot hole 101 and is fixed to the mounting plate 16, allowing the heating furnace 4 to move along the longitudinal direction Y of the frame 1.

As shown in FIGS. 1 to 6, in the illustrated embodiment, the heat shrink tube heating system further includes a driving device 6, which is installed on the top of the frame 1 to drive the heating furnace 4 to move along the longitudinal direction Y of the frame 1.

As shown in FIGS. 1 to 6, in the illustrated embodiment, the heat shrink tube heating system further includes a control cabinet 7, which is fixed to the frame 1 and has a control panel for controlling the heating furnace 4.

As shown in FIGS. 1 to 6, in the illustrated embodiment, the heat shrink tube heating system further includes a wheel 8, which is installed on the bottom of the frame 1, so that the heat shrink tube heating system can be moved on the ground through the wheel 8.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A heat shrink tube heating system comprising:
a frame;
a first fixture disposed on the frame for clamping one end of a cable product;
a second fixture disposed on the frame for clamping the other end of the cable product; and
a heating furnace mounted on the frame in a movable manner and having a heating channel that allows the cable product to pass through, wherein the heating furnace is movable along an axial direction of the clamped cable product between the first fixture and the second fixture, for heating a heat shrink tube on the cable product.

2. The heat shrink tube heating system according to claim 1, wherein the longitudinal direction of the frame is parallel to the axial direction of the clamped cable product, the first fixture and the second fixture are opposite in the longitudinal direction of the frame, and at least one of the first fixture and the second fixture is movable along the longitudinal direction of the frame for clamping cable products of different lengths.

3. The heat shrink tube heating system according to claim 2, wherein the first fixture is fixedly mounted on the frame, and the second fixture is moveably mounted on the frame and capable of being moved along the longitudinal direction of the frame.

4. The heat shrink tube heating system according to claim 3, wherein the first fixture comprises:
a first vertical bracket, the lower end of which is fixed to the top of the frame;
a horizontal bracket, one end of which is fixed to the upper end of the first vertical bracket;
a first V-shaped seat disposed on the horizontal bracket and having a first V-shaped groove for positioning the cable product; and
a first pressing mechanism disposed on the horizontal bracket and used to press one end of the cable product into the first V-shaped groove.

5. The heat shrink tube heating system according to claim 4, wherein the first pressing mechanism comprises:
a lever member, wherein a first threaded hole is formed on one end of the lever member;
a support member fixed on the horizontal bracket and rotatably connected to the lever member, so that the lever member can be rotated around a fulcrum;
a first screw threaded into the first threaded hole and passing through it; and
a first pressing plate rotatably connected to the other end of the lever member, wherein the lower end of the first screw rests against the horizontal bracket, and the first pressing plate is presses one end of the cable product into the first V-shaped groove.

6. The heat shrink tube heating system according to claim 5, wherein the distance from the fulcrum to the other end of the lever member is greater than the distance from the fulcrum to one end of the lever member, to increase the pressing force exerted by the first pressing plate on one end of the cable product.

7. The heat shrink tube heating system according to claim 3, wherein the second fixture comprises:
a second vertical bracket, the lower end of which is movably mounted on the frame and can be moved along the longitudinal direction of the frame;
a horizontal top plate fixed to the upper end of the second vertical bracket;
a second V-shaped seat fixed on the horizontal top plate and having a second V-shaped groove for positioning the cable product; and
a second pressing mechanism disposed on the second vertical bracket and pressing the other end of the cable product into the second V-shaped groove.

8. The heat shrink tube heating system according to claim 7, wherein the second pressing mechanism comprises:
a vertical rod, the lower end of which is fixed to the second vertical bracket;
an installation block disposed on the vertical rod and formed with a second threaded hole;
a second screw threaded into the second threaded hole and passing through the second threaded hole; and
a second pressing plate fixed to the lower end of the second screw, for pressing the other end of the cable product into the second V-shaped groove.

9. The heat shrink tube heating system according to claim 8, wherein:
the installation block is movably mounted on the vertical rod and can be moved along the vertical rod; and
the second pressing mechanism further comprises a locking device for locking the installation block onto the vertical rod.

10. The heat shrink tube heating system according to claim 7, wherein the frame comprises:
a top plate formed with a slot hole extending along the longitudinal direction of the frame;
a slide rail fixed to the inner side of the top plate and extending along the longitudinal direction of the frame;
a slider engaged with the slide rail to be able to move along the slide rail; and
a connecting plate fixed to the slider to move together with the slider, wherein the lower end of the second vertical bracket passes through the slot hole and is fixed to the connecting plate, so that the second fixture can be moved along the longitudinal direction of the frame.

11. The heat shrink tube heating system according to claim 1, wherein the heating furnace comprises:
a movable bracket, the lower end of which is movably mounted on the frame and capable of being moved along the longitudinal direction of the frame; and
a heating furnace body supported on the movable bracket and formed with the heating channel, wherein:
the heating furnace body comprises a lower half furnace body and an upper half furnace body combined together; and
the lower half furnace body is fixed to the movable bracket, and one side of the upper half furnace body is rotatably connected to one side of the lower half furnace body, so that the upper half furnace body can be rotatably opened and closed relative to the lower half furnace body.

12. The heat shrink tube heating system according to claim 11, wherein the heating furnace body has left and right sides opposite to each other in the transverse direction of the frame, and the left sides of the upper half furnace body and the lower half furnace body are rotatably connected together by a hinge.

13. The heat shrink tube heating system according to claim 12, wherein the heating furnace further comprises:
a first handle connected to the right side of the upper half furnace body to allow the operator to open or close the upper half furnace body by the first handle; and
a second handle connected to the right side of the lower half furnace body to allow the operator to drive the heating furnace to move along the longitudinal direction of the frame by the second handle.

14. The heat shrink tube heating system according to claim 11, wherein the heating furnace body has front and rear sides opposite to each other in the longitudinal direction of the frame.

15. The heat shrink tube heating system according to claim 14, wherein the heating furnace further comprises a cooling module installed on the front or rear side of the heating furnace body to cool the heating furnace body to a predetermined safe temperature.

16. The heat shrink tube heating system according to claim 15, wherein the cooling module comprises upper and lower cooling blocks respectively fixed to the upper and lower half furnace bodies, and a circular through hole aligned with the heating channel of the heating furnace body and allowing the cable product to pass through is formed in the cooling module.

17. The heat shrink tube heating system according to claim 11, wherein the frame comprises:
a top plate formed with a slot hole extending along the longitudinal direction of the frame;
a slide rail fixed to the inner side of the top plate and extending along the longitudinal direction of the frame;
a sliding block that is engaged with the slide rail to be able to move along the slide rail; and
a mounting plate fixed to the sliding block to be moved together with the sliding block, wherein the lower end of the movable bracket passes through the slot hole and is fixed to the mounting plate, allowing the heating furnace to move along the longitudinal direction of the frame.

18. The heat shrink tube heating system according to claim 11, further comprising a driving device installed on the top of the frame to drive the heating furnace to move along the longitudinal direction of the frame.

19. The heat shrink tube heating system according to claim 1, further comprising a control cabinet fixed to the frame and having a control panel for controlling the heating furnace.

20. The heat shrink tube heating system according to claim 1, further comprising a wheel installed on the bottom of the frame and allowing the heat shrink tube heating system to move on the ground through the wheel.
